(19) United States
(12) Patent Application Publication
(10) Pub. No.: US 2019/0354143 A1
(43) Pub. Date: Nov. 21, 2019

(54) Information Processing Terminal And Hinge Unit

(71) Applicant: FUJITSU CLIENT COMPUTING LIMITED, Kawasaki-Shi (JP)

(72) Inventor: Akimasa NISHIKAWA, Kawasaki-shi (JP)

(21) Appl. No.: 16/433,086

(22) Filed: Jun. 6, 2019

Related U.S. Application Data
(63) Continuation of application No. PCT/JP2017/043973, filed on Dec. 7, 2017.

(30) Foreign Application Priority Data
Jan. 5, 2017 (JP) 2017-000762

(51) Int. Cl. G06F 1/16

(52) U.S. Cl. CPC G06F 1/1681; G06F 1/1616; G06F 1/1683

(57) ABSTRACT

An information processing terminal including a first housing; a second housing; and a hinge unit connecting the first housing and the second housing so as to be able to be opened and closed; wherein the first housing includes at least two screw fastening portions, each having a screw hole, to which a bracket provided on the hinge unit is attached, and also comprises a boss portion having a space that is recessed towards an area between the screw holes; and the bracket includes screw holes corresponding to at least the two screw fastening portions provided in the boss portion, and comprises a notch portion that, when the bracket is attached to the boss portion, hooks a cable installed in the first housing at a position corresponding to the space in the boss portion.

This application is a continuation application based on a PCT International Application No. PCT/JP2017/043973, filed on Dec. 7, 2017, whose priority is claimed on Japanese Patent Application No. 2017-000762, filed Jan. 5, 2017. Both of the content of the PCT International Application and the Japanese Application are incorporated herein by reference.

### FIELD OF THE INVENTION

The invention disclosed in the present description relates to an information processing terminal and a hinge unit.

### DESCRIPTION OF RELATED ART

Conventionally, information processing terminals such as, for example, personal computers (PCs) of the so-called notebook type or clamshell type are known, for example, as shown in Japanese Unexamined Patent Application, First Publication No. 2007-249901 or Japanese Unexamined Patent Application, First Publication No. 2008-250635. Such information processing terminals have a display housing and a body housing that are connected, by a hinge unit, so as to be able to be opened and closed, and a cable reeled off from the display housing is sometimes drawn into the body housing. In such a case, it has been proposed to wire the cable along a wiring route passing through the hinge unit.

### SUMMARY OF THE INVENTION

Conventionally, for example, when fixing a cable that is provided inside a display housing, there were cases in which a bracket provided on the hinge unit was fixed to a rear cover of the display housing with the cable passing between the bracket and the rear cover. However, when screwing the bracket to the rear cover, if the cable is not guided to an appropriate position, there is a possibility that the cable will not be able to pass between the bracket and the rear cover, and be pinched, making the assembly work difficult. Patent Document 1 and Patent Document 2 both involve routing the cable on the outside of the display housing and thus do not consider how to avoid pinching the cable inside the display housing.

In one aspect, the information processing terminal and the hinge unit disclosed in the present description address the problem of easily routing a cable inside the housings.

An information processing terminal disclosed in the present description comprises a first housing; a second housing; and a hinge unit configured to connect the first housing and the second housing openably and closably; wherein the first housing comprises at least two screw fastening portions, each having a screw hole, to which a bracket provided on the hinge unit is attached, and also comprises a boss portion having a space that is recessed towards an area between the screw holes; and the bracket comprises screw holes corresponding to at least the two screw fastening portions provided in the boss portion, and comprises a notch portion that, when the bracket is attached to the boss portion, hooks a cable installed in the first housing at a position corresponding to the space in the boss portion.

A hinge unit disclosed in the present description is a hinge unit that connects a first housing and a second housing openably and closably, that comprises at least two or more screw holes, and that comprises a bracket comprising a notch portion extending from an edge portion towards an area between the screw holes.

### BRIEF DESCRIPTION OF THE DRAWINGS

FIG. 1 is a perspective view of an information processing terminal according to a first embodiment.

FIG. 2 is a perspective view of a display housing provided in the information processing terminal according to the first embodiment.

FIG. 3 is an exploded perspective view of a display housing provided in the information processing terminal according to the first embodiment.

FIG. 4 is a perspective view showing the display housing provided in the information processing terminal according to the first embodiment, with a front cover removed.

FIG. 5 is an explanatory view showing an enlargement of the periphery of the display-side bracket on the left side of the first embodiment.

FIG. 6 is an explanatory view showing an enlargement of the periphery of the display-side bracket on the left side of the first embodiment.

FIG. 7A is an explanatory view showing the display-side bracket on the left side of the first embodiment, in a removed state; FIG. 7B is an explanatory view showing boss portion.

FIG. 8 is a perspective view of a display-side bracket in the first embodiment.

FIG. 9 is a perspective view of a display-side bracket in the first embodiment.

FIG. 10A to 10F are six views of the display-side bracket in the first embodiment.

FIG. 11A is an explanatory view showing the schematic structure of a display-side bracket according to a second embodiment; FIG. 11B is an explanatory view showing the schematic structure of a modified example of the display-side bracket according to the second embodiment.

FIG. 12 is an explanatory view showing the schematic structure of a display-side bracket according to a third embodiment.

FIG. 13 is an explanatory view showing the schematic structure of a display-side bracket according to a fourth embodiment.

FIG. 14 is an explanatory view showing the schematic structure of a display-side bracket according to a fifth embodiment.

### BRIEF DESCRIPTION OF THE INVENTION

Hereinafter, embodiments of the present invention will be explained with reference to the attached drawings. However, in the drawings, there are cases in which the dimensions, ratios and the like of the respective parts are not illustrated so as to completely match those of the actual parts. Additionally, depending on the drawing, there are cases in which structural elements that are actually present have been omitted, or dimensions have been exaggerated in comparison to the actual values for purposes of explanation.

### First Embodiment

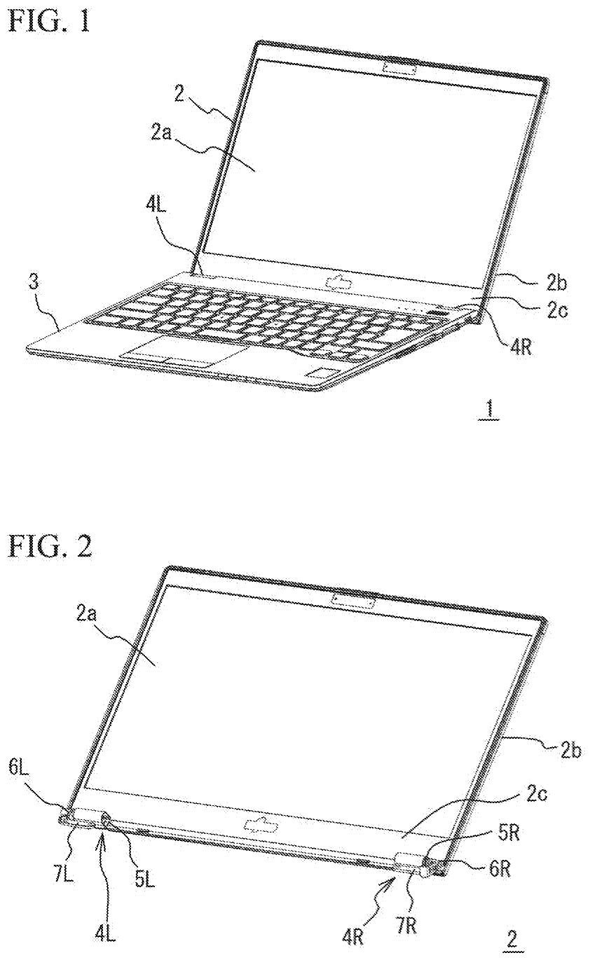

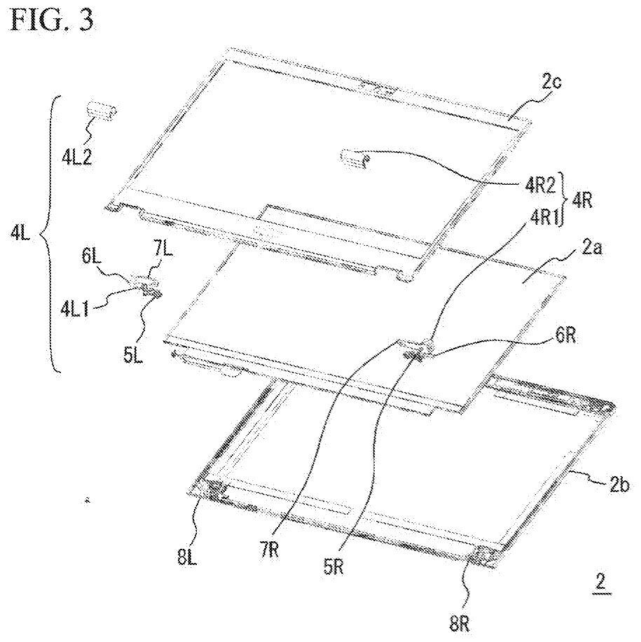

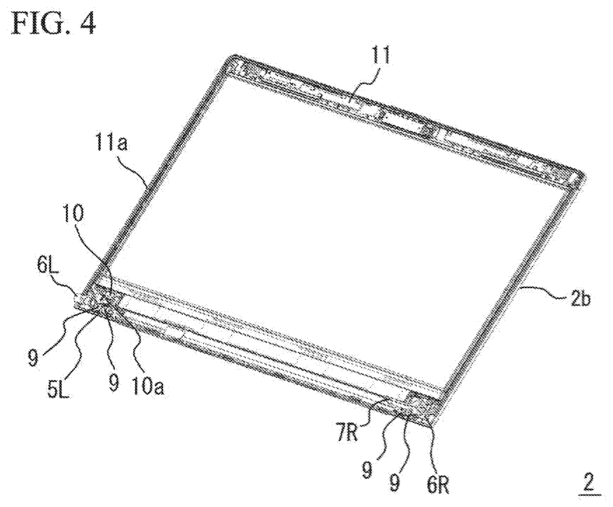

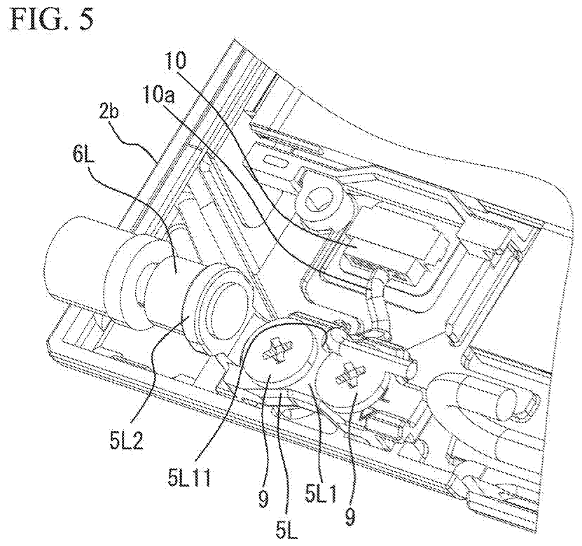

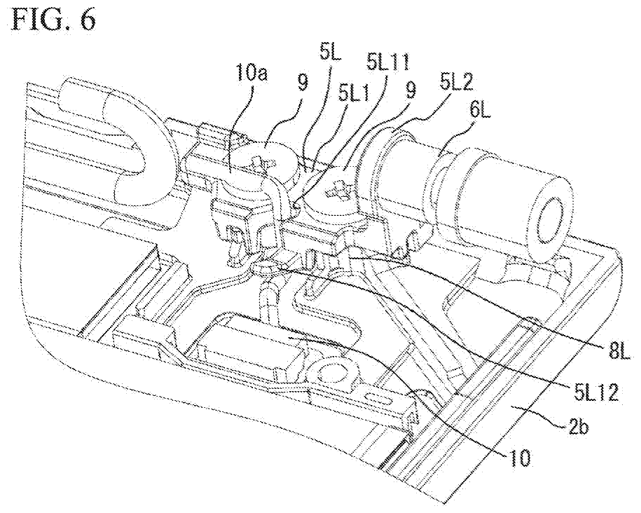

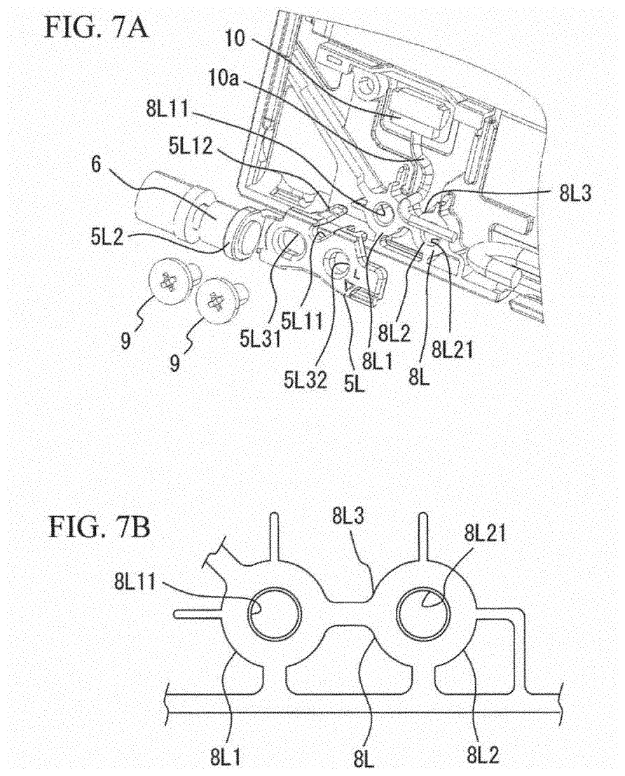

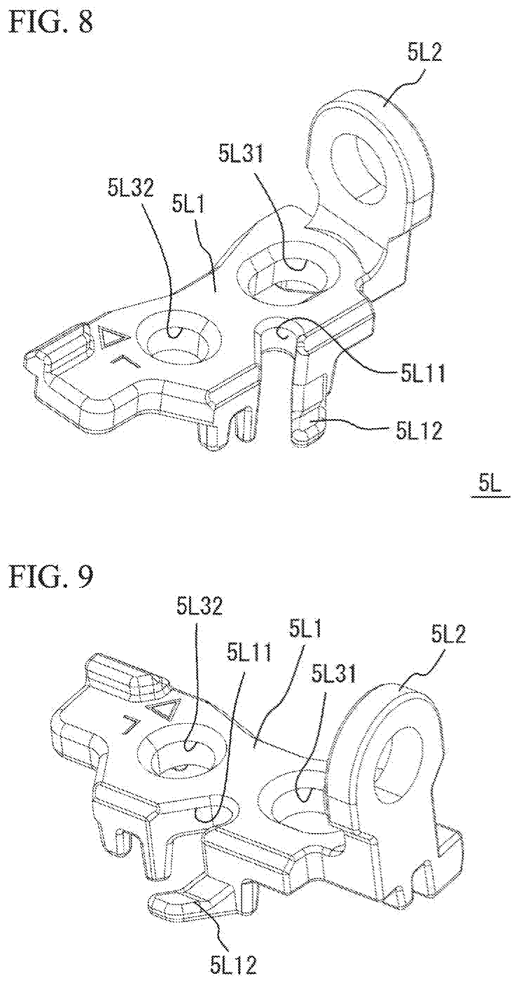

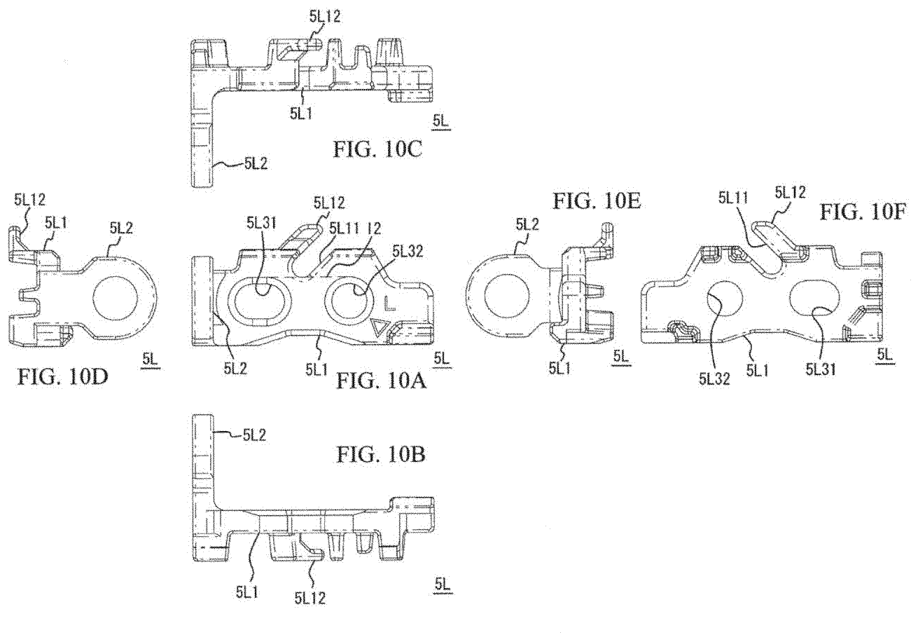

First, an information processing terminal 1 according to a first embodiment will be explained with reference to FIG. 1 to 10. FIG. 1 is a perspective view of the information processing terminal according to the first embodiment. FIG. 2 is a perspective view of a display housing provided in the information processing terminal according to the first embodiment. FIG. 3 is an exploded perspective view of a display housing provided in the information processing terminal according to the first embodiment. FIG. 4 is a perspective view showing the display housing provided in the information processing terminal according to the first embodiment, with a front cover removed. FIG. 5 is an explanatory view showing an enlargement of the display-side bracket on the left side of the first embodiment. FIG. 6 is an explanatory view showing an enlargement of the display-side bracket on the left side of the first embodiment. FIG. 7A is an explanatory view showing the display-side bracket on the left side of the first embodiment, in a removed state, and FIG. 7B is an explanatory view showing boss portion. FIG. 8 is a perspective view of a display-side bracket in the first embodiment. FIG. 9 is a perspective view of a display-side bracket in the first embodiment. FIG. 10A to 10F are six views of the display-side bracket in the first embodiment. FIG. 10A is a plan view, FIG. 10B is a front view, FIG. 10C is a rear view, FIG. 10D is a left side view, FIG. 10E is a right side view and FIG. 10F is a bottom view.

The information processing terminal 1 in the present embodiment is a so-called notebook PC, comprising a display housing 2 and a body housing 3, as depicted in FIG. 1. Additionally, the display housing 2 comprises a liquid crystal display 2a, a rear cover 2b and a front cover 2c, as depicted in FIGS. 2 to 4. In other words, the display housing 2 is formed by attaching the front cover 2c to the rear cover 2b, which houses the liquid crystal display 2a. The display housing 2 is an example of a first housing. Referring to FIG. 4, an antenna 11 is provided inside the display housing 2, and an antenna wire 11a is wired along an edge portion of the rear cover 2b. The display housing 2 is connected, by means of a left hinge portion 4L and a right hinge portion 4R, to the body housing 3, which is an example of a second housing. The left hinge portion 4L includes a hinge unit 4L1 and a hinge cover 4L2 for covering the hinge unit 4L1. The right hinge portion 4R similarly includes a hinge unit 4R1 and a hinge cover 4R2. The hinge covers 4L2 and 4R2 are respectively for only covering the hinge units 4L1 and 4R1, so the display housing 2 and the body housing 3 are connected so as to be able to be opened and closed by the hinge units 4L1 and 4R1. A motherboard or the like is housed inside the body housing 3. A keyboard or the like is provided on the body housing 3.

The hinge unit 4L1 contained in the left hinge portion 4L, for example, referring to FIG. 3, comprises a display-side bracket 5L, a shaft member 6L and a body-side bracket 7L. The hinge unit 4R1 contained in the right hinge portion 4R similarly comprises a display-side bracket 5R, a shaft member 6R and a body-side bracket 7R. In FIG. 4, the body-side bracket 7L contained in the left hinge portion 4L is omitted.

The hinge unit 4L1 is attached to the display housing 2 by the display-side bracket 5L being screwed to the rear cover 2b of the display housing 2. The rear cover 2b is provided with a boss portion 8L and a boss portion 8R.

Referring to FIG. 7A and FIG. 7B, the boss portion 8L includes two screw fastening portions, namely, a first screw fastening portion 8L1 and a second screw fastening portion 8L2, to which is attached the display-side bracket 5 provided on the hinge unit 4L1. In other words, the boss portion 8L is formed by providing the first screw fastening portion 8L1 and the second screw fastening portion 8L2 integrally so as to protrude towards the front cover 2c from the inner side of the rear cover 2b. The first screw fastening portion 8L1 is provided with a screw hole 8L11 and the second screw fastening portion 8L2 is provided with a screw hole 8L21. Furthermore, on the boss portion 8L, a recessed space 8L3 is formed so as to be recessed towards the area between the two screw holes 8L11 and 8L21. The space 8L3 accommodates a cable 10a, as will be explained in detail below.

The boss portion 8R is also provided on the inner side of the rear cover 2b so as to protrude towards the front cover 2c. The first screw fastening portion, the second screw fastening portion and the recessed space included in the boss portion 8R are similar to those in the boss portion 8L, so a detailed explanation thereof will be omitted.

While the rear cover 2b in the present embodiment comprises two screw fastening portions in a single hinge unit, the number of screw fastening portions is not limited thereto, and there may be three or more.

Referring to FIG. 8 to 10, the hinge unit 4L1 comprises a display-side bracket 5L. The display-side bracket 5L comprises a flat fixation portion 5L1. The fixation portion 5L1 comprises a first screw hole 5L31 corresponding to the screw hole 8L11 in the first screw fastening portion 8L1 provided in the boss portion 8L, and a second screw hole 5L32 corresponding to the screw hole 8L21 in the second screw fastening portion 8L2 provided in the boss portion 8L. A screw 9 is inserted in the first screw hole 5L31 and the second screw hole 5L32, as depicted in FIG. 7A. As a result thereof, the hinge unit 4L1 is attached to the boss portion 8L. The display-side bracket 5L comprises a notch portion 5L11 at a position corresponding to the space 8L3 in the boss portion 8L when in a state of attachment to the boss portion 8L. A cable 10a is hooked to this notch portion 5L11.

The fixation portion 5L1 is roughly rectangular, and the mouth portion of the notch portion 5L11 is located on a lengthwise edge portion thereof. The notch portion 5L11 in the present embodiment extends diagonally with respect to the edge portion. The direction of extension of the notch portion 5L11 may be changed as appropriate in accordance with the mode of wiring of the cable 10a.

The hinge unit 4L1 comprises a pressing portion 5L12 at the mouth portion of the notch portion 5L11. The pressing portion 5L12 protrudes in the direction opposite to the direction of extension of the notch portion 5L11. The pressing portion 5L12 clamps the cable 10a against the rear cover 2b of the display housing 2 when the hinge unit 4L1 is in a state of attachment to the boss portion 8L. As a result thereof, it is possible to suppress the rising of the cable 10a.

The cable 10a will be explained. The cable 10a in the present embodiment extends from a connector 10. The connector 10 is inserted near the boss portion 8L and the cable 10a is routed towards the center of the display housing 2. In the present embodiment, such a cable 10a is hooked to the notch portion 5L11. The hinge unit 4L1 is screwed to the boss portion 8L in a state avoiding the cable 10a, and thereafter, the cable 10a is hooked to the notch portion 5L11. By doing so, it is possible to keep the cable 10a from being pinched. Alternatively, the hinge unit 4L1 may be screwed to the boss portion 8L with the cable 10a hooked to the notch portion 5L11. Since the notch portion 5L11 is provided so as to correspond to the space 8L3 in the boss portion 8L, the cable 10a hooked to the notch portion 5L11 is in a state of being accommodated inside the space 8L3. This also contributes to suppressing the pinching of the cable 10a.

Referring to FIG. 8 and FIG. 9, the display-side bracket 5L comprises a bearing portion 5L2 that stands upright at the end of the fixation portion 5L1. An attachment hole, to which a shaft member 6L is to be attached, is formed in the bearing portion 5L2. The center point of this attachment hole is aligned with the central axis of the shaft member 6L. A body-side bracket 7L is attached to the shaft member 6L. The body-side bracket 7L is attached to the body housing 3. As a result thereof, the display housing 2 and the body housing 3 are connected so as to be able to open and close.

The hinge unit 4R1 of the right hinge portion 4R has substantially the same structure, so a detailed description thereof will be omitted.

### Second Embodiment

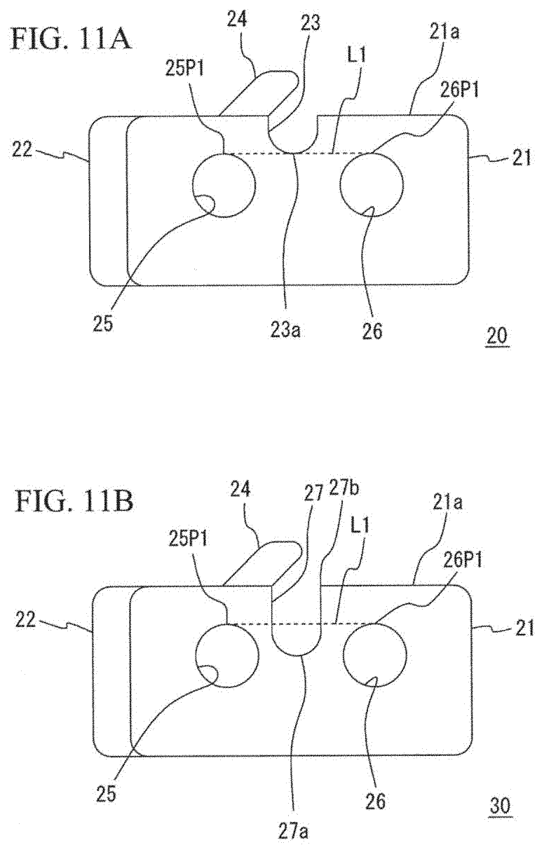

Next, a second embodiment will be explained with reference to FIG. 11A and FIG. 11B. FIG. 11A is an explanatory view showing the schematic structure of a display-side bracket according to the second embodiment, and FIG. 11B is an explanatory view showing the schematic structure of a modified example of the display-side bracket according to the second embodiment. The embodiments described below all differ from the first embodiment in terms of the shape of the display-side bracket and the like. Therefore, in the following descriptions, the descriptions will focus on the differences from the first embodiment.

Referring to FIG. 11A, the display-side bracket 20 comprises a fixation portion 21 and a bearing portion 22 connected thereto. The flat fixation portion 21 is roughly rectangular, and comprises a first screw hole 25 and a second screw hole 26 provided so as to be aligned along the lengthwise direction. Furthermore, a notch portion 23 having a mouth portion that is located on an edge portion 21a along the lengthwise direction of the fixation portion 21 is provided. Additionally, a pressing portion 24 is provided. The depth of the notch portion 23 will be explained. In the display-side bracket 20 depicted in FIG. 11A, the position of the bottom portion 23a of the notch portion 23 is approximately aligned with the position of the tangent line L1. In this case, the tangent line L1 is a line segment passing through a point 25P1 on the first screw hole 25 and a point 26P1 on the second screw hole 26 on the side closer to the edge portion 21a on which the mouth portion of the notch portion 23 is located.

On the other hand, in the display-side bracket 30 depicted in FIG. 11B, a notch portion 27 is provided instead of the notch portion 23 in the display-side bracket 20, and the bottom portion 27a thereof extends further inward than the tangent line L1. In other words, the bottom portion 27a of the notch portion 27 is arranged to lie further inward than the tangent line L1 connecting the circumferential edge of the first screw hole 25 with the circumferential edge of the second screw hole 26 on the side towards the edge of the fixation portion 21 in which the mouth portion 27b of the notch portion 27 is located.

While the notch portion 23 provided in the display-side bracket 20 depicted in FIG. 11A can also hook a cable 10a, it is shallower than the notch portion 27 provided in the display-side bracket 30 depicted in FIG. 11B. The notch portion 23 and the notch portion 27 are provided at positions corresponding to the space 8L3, and the hooked cable 10a is accommodated in the space 8L3. If the diameter of the cable 10a is small, then there is no problem, but if the diameter of the cable 10a is rather large, then it is preferable to provide more depth, as in the notch portion 27. Additionally, even if the diameter of the cable 10a is small, the cable 10a can be appropriately hooked and held as long as adequate depth is provided as in the notch portion 27.

### Third Embodiment

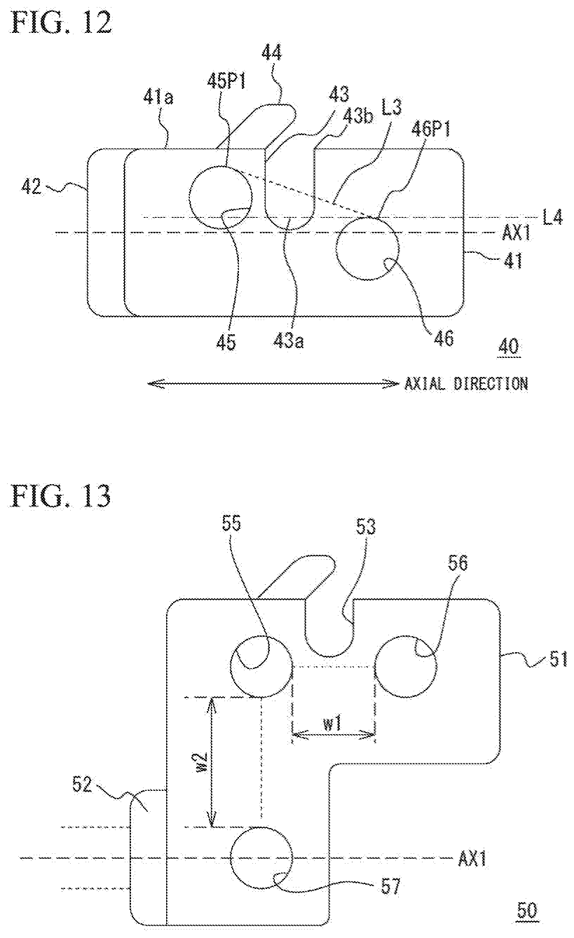

Next, a third embodiment will be explained with reference to FIG. 12. FIG. 12 is an explanatory view showing the schematic structure of a display-side bracket according to the third embodiment.

Referring to FIG. 12, a display-side bracket 40 comprises a fixation portion 41 and a bearing portion 42 connected thereto. The flat fixation portion 41 is roughly rectangular, and comprises a first screw hole 45 and a second screw hole 46 provided so as to be aligned along the lengthwise direction. Furthermore, a notch portion 43 having a mouth portion 43b that is located on an edge portion 41a along the lengthwise direction of the fixation portion 41 is provided. Additionally, a pressing portion 44 is provided.

The display-side bracket 40 differs from the display-side bracket 20 and the display-side bracket 30 in the second embodiment in terms of the arrangement of the first screw hole 45 and the second screw hole 46. In the second embodiment, the first screw hole 25 and the second screw hole 26 were arranged along the rotation axis passing through the bearing portion 22. In contrast therewith, in the third embodiment, the second screw hole 46 is provided at a position that is further from the edge portion 41a than the first screw hole 45 is. For this reason, on the side closer to the edge portion 41a on which the mouth portion 43b of the notch portion 43 is located, a tangent line L3 passing through a point 45P1 on the first screw hole 45 and a point 46P1 on the second screw hole 46 is tilted with respect to the rotation axis AX1.

In the display-side bracket 40 on which the first screw hole 45 and the second screw hole 46 are arranged so as to be offset, the bottom portion 43a of the notch portion 43 is located not only past the tangent line L3, but also further inward than the tangent line L4 is. In this case, the tangent line L4 is a line segment that passes through a point 46P1 on the circumferential edge of the second screw hole 46 provided at a position that is further from the edge portion 41a than the first screw hole 45 is and that is parallel to the rotation axis AX1 of the hinge unit. When the alignment direction of the first screw hole 45 and the second screw hole 46 is tilted with respect to the rotation axis AX1 in this way, the alignment direction of the first screw fastening portion and the second screw fastening portion provided in the boss portion will also be tilted with respect to the rotation axis AX1. In such a case, in order for the cable 10a to be appropriately accommodated in the space formed between the first screw fastening portion and the second screw fastening portion, it is more favorable for the notch portion 43 to be provided as deeply as possible. For this reason, by arranging the position of the bottom portion 43a of the notch portion 43 to lie further inward than the tangent line L4, it is possible to accommodate the cable 10a that is hooked to the notch portion 43 inside the space in the boss portion. As a result thereof, it is possible to keep the cable 10a from being pinched and to easily route the cable inside the display housing 2.

### Fourth Embodiment

Next, a fourth embodiment will be explained with reference to FIG. 13. FIG. 13 is an explanatory view showing the schematic structure of a display-side bracket according to the fourth embodiment.

The display-side bracket 50 of the fourth embodiment comprises a fixation portion 51 and a bearing portion 52 connected thereto. The flat fixation portion 51 is roughly L-shaped. Furthermore, a first screw hole 55 and a second screw hole 56 are aligned along the direction of extension of the rotation axis AX1. Additionally, the first screw hole 55 and a third screw hole 57 are aligned along the direction perpendicular to the rotation axis AX1. The distance w1 between the first screw hole 55 and the second screw hole 56 is less than the distance w2 between the first screw hole 55 and the third screw hole 57. Furthermore, a notch portion 53 is provided between the first screw hole 55 and the second screw hole 56, which are separated by the shorter distance.

When the distance between screw holes becomes wider, it can be expected that a boss portion corresponding thereto will not be integrally molded and an embodiment in which a space is formed in the boss portion will not be employed. In the boss portion to which the display-side bracket 50 is attached in the fourth embodiment, a first screw fastening portion corresponding to the first screw hole 55 and a second screw fastening portion corresponding to the second screw hole 56 are formed integrally. Furthermore, in the present embodiment, a notch portion 53 is formed between the first screw hole 55 and the second screw hole 56.

### Fifth Embodiment

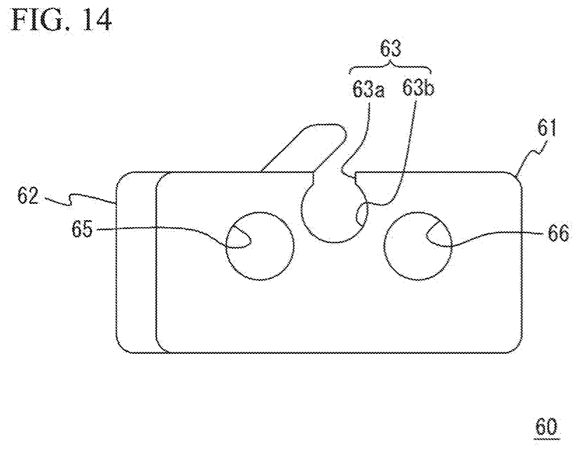

Next, a fifth embodiment will be explained with reference to FIG. 14. FIG. 14 is an explanatory view showing the schematic structure of a display-side bracket according to the fifth embodiment.

The display-side bracket 60 comprises a fixation portion 61 and a bearing portion 62 connected thereto. The flat fixation portion 61 is roughly rectangular, and comprises a first screw hole 65 and a second screw hole 66 provided so as to be aligned along the lengthwise direction. Furthermore, a notch portion 63 having a mouth portion that is located on an edge portion along the lengthwise direction of the fixation portion 61 is provided. The mouth portion of the notch portion 63 forms a reduced-diameter portion 63a. Furthermore, the inner side forms an enlarged-diameter portion 63b. When hooking a cable 10a to this notch portion 63, the cable 10a is pushed in so as to pass through the reduced-diameter portion 63a. As a result thereof, it is made difficult for the cable 10a to come loose and the cable 10a is kept from being pinched. Once the cable 10a passes the reduced-diameter portion 63a, it is held inside the enlarged-diameter portion 63b. For this reason, the load applied to the cable 10a is reduced.

While preferred embodiments of the present invention have been explained in detail above, the present invention is not limited to these specific embodiments, and various modifications and changes are possible within a range not departing from the gist of the present invention as recited in the claims.

What is claimed is:

1. An information processing terminal comprising:
a first housing;
a second housing; and
a hinge unit configured to connect the first housing and the second housing openably and closably; wherein
the first housing comprises at least two screw fastening portions, each having a screw hole, to which a bracket provided on the hinge unit is attached, and also comprises a boss portion having a space that is recessed towards an area between the screw holes; and
the bracket comprises screw holes corresponding to at least the two screw fastening portions provided in the boss portion, and comprises a notch portion that, when the bracket is attached to the boss portion, hooks a cable installed in the first housing at a position corresponding to the space in the boss portion.

2. The information processing terminal according to claim 1, wherein the hinge unit comprises a cable pressing portion that clamps the cable against the first housing when the hinge unit is attached to the boss portion.

3. The information processing terminal according to claim 1, wherein a bottom portion of the notch portion is arranged to lie further inward than a tangent line connecting circumferential edges of the two screw holes on a side towards an edge of the bracket on which a mouth portion of the notch portion is located.

4. The information processing terminal according to claim 1, wherein the bottom portion of the notch portion is arranged to lie further inward than a tangent line that is parallel to the rotation axis of the hinge unit and that passes through circumferential edges of the screw holes on a side towards an edge of the bracket on which a mouth portion of the notch portion is located.

5. The information processing terminal according to claim 1, wherein the bracket comprises three or more screw holes, and the notch portion is provided between the screw holes that are separated by the shortest distance among the screw holes.

6. The information processing terminal according to claim 1, wherein the notch portion comprises a reduced-diameter portion at the mouth portion.

7. A hinge unit that configured to connect a first housing and a second housing openably and closably,
wherein the hinge unit comprises a bracket comprising at least two or more screw holes, and comprises a notch portion extending from an edge portion towards an area between the screw holes.
